(19) United States
(12) Patent Application Publication
(10) Pub. No.: US 2004/0136807 A1
(43) Pub. Date: Jul. 15, 2004

(54) Thread repair insert

(75) Inventor: Thomas F. Foerster JR., Eagle River, WI (US)

Correspondence Address: FOLEY AND LARDNER, SUITE 500, 3000 K STREET NW, WASHINGTON, DC, 20007, US

(73) Assignee: GARD Specialists Co., Inc.

(21) Appl. No.: 10/338,658

(22) Filed: Jan. 9, 2003

(51) Int. Cl. F16B 37/12

(52) U.S. Cl. 411/178

(57) ABSTRACT

A thread repair insert includes an external surface at least partially threaded, and at least one containment recess formed in the external surface and spaced a distance from a leading end of the insert. The containment recess includes at least one cutting edge for cutting material to form threads and is configured to retain substantially all of the cut material. The annular sleeve can be formed of through hardened metal. The internal surface can include at least a portion with pipe threads. The thread repair insert can be used to repair damaged threads.

### BACKGROUND OF THE INVENTION

A. Field of the Invention

The present invention relates generally to thread repair inserts, and, more particularly, to thread repair inserts having at least one cutting edge for cutting material to form threads.

B. Description of the Related Art

Tap and die tools for forming and repairing threads are known in the art. These tools are commonly used to repair a threaded hole after the threads have been damaged in some way, e.g., stripped. Typically, the damaged threads are first drilled out, using a drill bit having a slightly larger diameter than the diameter of the original threaded hole, to completely remove the damaged threads. A removable tap is then coaxially aligned with the hole, and rotated into the hole to cut new threads in the hole.

Instead of using tap and die tools, thread repair inserts can be used to provide new threads. A thread repair insert typically includes an annular sleeve or a helical coil. The annular-sleeve-type insert often has a threaded external surface and a threaded internal surface. The damaged hole is first drilled out to remove the damaged threads. The thread repair insert is then coaxially aligned with the hole, and the threaded external surface of the thread repair insert cuts new threads as it is rotated and inserted into the hole. The thread repair insert then remains in the hole. The threaded internal surface of the thread repair insert provides a new threaded hole for receiving a threaded fastener, such as a bolt.

One known thread repair insert has through holes in the annular sleeve that provide cutting surfaces and cause the sleeve to “lock” into the base material. The cutting surfaces allow for self-tapping during insertion of the thread repair insert. During insertion, cut material passes through the through holes into the center of the insert, where it collects inside the hole (if the hole extends below the insert) and/or on the insert itself. This can be particularly problematic in applications where it is undesirable to have foreign materials, such as the cut material, inside the hole and/or the insert. For example, when cutting threads in pipes, it is necessary to flush out the pipe after cutting the new threads to remove the cut material. Flushing is required because the flow path must be unobstructed and free of contaminants.

Another known thread repair insert has an annular sleeve with a plurality of recessed stop grooves extending from a leading edge of the insert. The recessed stop grooves are provided with curved side walls for cutting threads as the insert is rotated during insertion. During insertion, cut material drops out from below the leading edge of the insert as it is rotated. As noted above, this is problematic in applications where it is undesirable to have foreign materials inside the hole and/or the insert.

Furthermore, internally threaded surfaces on known thread repair inserts are straight. Thus, known thread repair inserts cannot be used for applications which require tapered threaded holes, such as tapered pipe threading.

### SUMMARY OF THE INVENTION

An aspect of the present invention relates to a thread repair insert. The thread repair insert includes an external surface at least partially threaded, and at least one containment recess formed in the external surface and spaced a distance from a leading end of the insert. The containment recess includes at least one cutting edge for cutting material to form threads and is configured to retain substantially all of the cut material.

Another aspect of the present invention relates to a thread repair insert that includes an annular sleeve. The annular sleeve includes an external surface including at least a portion that is threaded, an internal surface including at least a portion that is threaded and tapers inward in a direction from a trailing end toward a leading end of the annular sleeve, and a cutting edge formed on the external surface for cutting material to form threads.

Another aspect of the present invention relates to thread repair insert that includes an annular sleeve. The annular sleeve includes a cutting edge for cutting material to form threads. The annular sleeve is formed of through-hardened metal.

Another aspect of the present invention relates to thread repair insert that includes an annular sleeve. The annular sleeve includes an external surface including at least a portion with threads, an internal surface including at least a portion with pipe threads and adapted to sealably couple to a threaded pipe, and a cutting edge formed on the external surface for cutting material to form threads.

Another aspect of the present invention relates to a method of repairing damaged threads. The method includes aligning a thread repair insert with a leading edge of a hole, rotating the thread repair insert, tapping into the pilot hole with at least one cutting edge of the thread repair insert while rotating the thread repair insert, and storing substantially all of the cut material in a containment recess on an external surface of the thread repair insert.

### BRIEF DESCRIPTION OF THE DRAWINGS

FIG. 1 is a perspective view of an embodiment of a thread repair insert according to the present invention.

FIG. 2 is an enlarged cross-sectional view of the thread repair insert of FIG. 1 cut along plane II-II.

FIG. 2A is an enlarged cross-sectional view of the thread repair insert of FIG. 1, cut along plane II-II, with a modified threaded portion.

FIG. 3 is an exploded side view (with a sleeve shown in cross section) of an embodiment of an installation tool for installing a thread repair insert according to the present invention.

FIGS. 4A to 4F are a series of side views (with a parent material shown in cross section) showing stages of installation of the thread repair insert of FIG. 1 using the installation tool of FIG. 3.

FIG. 5 is a cross-sectional view of an alternative embodiment of a stud of the installation tool of FIG. 3.

FIGS. 6A to 6F are a series of side views (with a parent material shown in cross section) showing stages of installation of the thread repair insert of FIG. 1 using the installation tool of FIG. 3 including the modification shown in FIG. 5.

### DETAILED DESCRIPTION OF THE PREFERRED EMBODIMENTS

Reference will now be made in detail to preferred embodiments of the invention. An effort has been made to use the same reference numbers throughout the drawings to refer to the same or like parts.

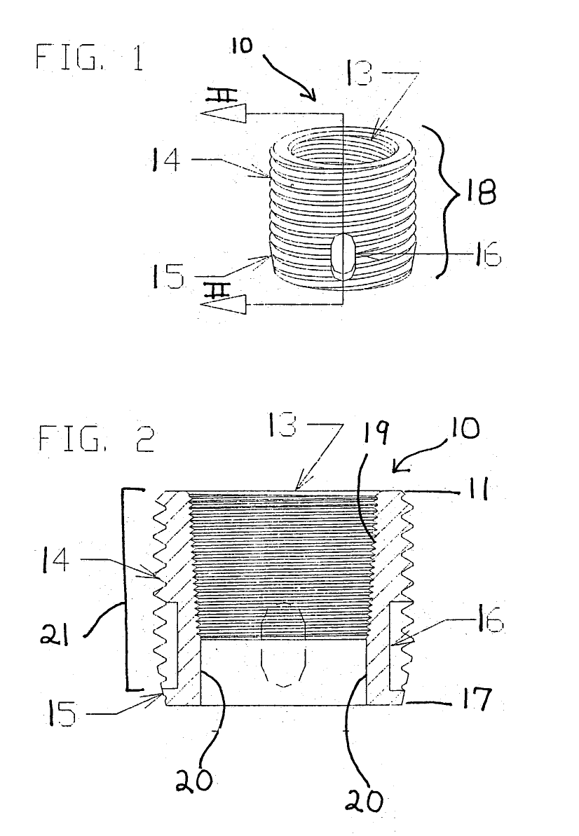

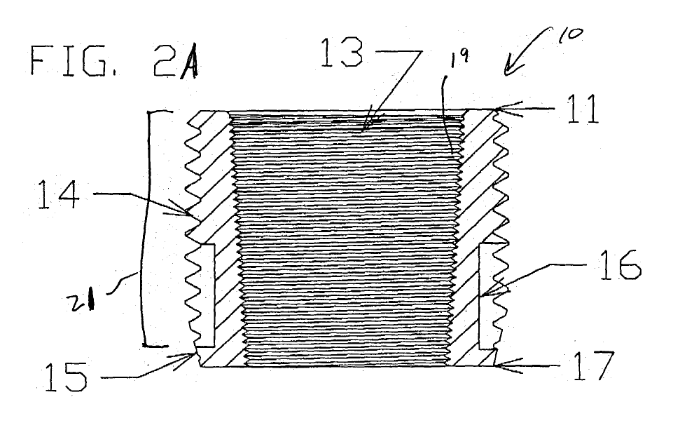

FIGS. 1 and 2 show an embodiment of a thread repair insert 10 according to the present invention. The thread repair insert 10 comprises an annular sleeve 18 including an internal surface 13, an external surface 14, and containment recesses 16. As explained in more detail below, the annular sleeve 18 can be inserted into a hole to provide a new threaded hole for receiving a threaded member (not shown), such as a pipe or a bolt.

The internal surface 13 preferably includes at least a portion 19 (see FIG. 2) that is threaded. The threaded portion 19 can be configured to receive and couple in sealed engagement to the threaded member. Characteristics of the threaded portion 19, such as its length and tapering angle, will vary depending on the threaded member it is designed to receive. For example, if the threaded member is intended to be a pipe, the threaded portion 19 preferably tapers inward in a direction from a trailing end 11 toward a leading end 17 of the annular sleeve 18. As another example, if the threaded member is intended to be a bolt, the threaded portion 19 preferably has a constant diameter. For example, the internal thread diameter can be about 1/2-13 UNC inside diameter. The internal surface 13 could include an unthreaded portion 20, which can have a constant diameter or can be tapered. Alternatively, the threaded portion 19 could extend over the entire internal surface 13, as shown in FIG. 2A.

The external surface 14 can be configured to form threads in the parent material into which the thread repair insert 10 is installed and to couple in sealed engagement to the parent material. The external surface 14 preferably includes at least a portion that is threaded. In this preferred embodiment, the entire external surface 14 is threaded. Also in this preferred embodiment, the external surface 14 has a tapered portion 15 and a non-tapered portion 21.

The tapered portion 15 allows for engagement of the thread repair insert 10 and the parent material. The tapering angle of the tapered portion 15 preferably is within the range of about 8° to about 18°. The tapering angle and the length of the tapered portion 15 may vary depending upon the inner and outer diameters of the thread repair insert 10 and the thread pitch of the external surface 14.

The non-tapered portion 21 preferably has a substantially constant outer diameter and is threaded from the tapered portion 15 to a trailing edge 11 of the annular sleeve 18. For example, the outer diameter can be 1⅛-12 UNF. This threaded portion beyond the containment recesses 16 can be designed to roll-form the newly cut threads, and preferably creates a gas-tight, self-sealing, and self-locking engagement with the parent material. Though the thread repair insert 10 is thus designed to be self-locking and/or self-sealing with respect to the parent material, a thread locking fluid may be used to enhance these attributes.

The containment recesses 16 are formed in the external surface 14, preferably by milling. The containment recesses 16 provide a graduated cutting edge on the external surface 14 for cutting parent material to form threads. The containment recesses 16 are preferably spaced a distance, such as approximately one to two threads, from the leading end 17 to allow for initializing the threading engagement with the parent material. As shown in FIG. 2, the containment recesses 16 are preferably spaced approximately equidistantly about the external surface 14.

The containment recesses 16 are configured to retain substantially all of the material cut during insertion. In particular, the containment recesses 16 do not penetrate entirely through the annular sleeve 18 and are spaced at a distance from the leading end 17. The containment recesses 16 are configured such that they can retain substantially all of the cut material (preferably they retain all of the material). By retaining substantially all of the material cut during insertion, it is not necessary to flush out the parent material after cutting the new threads to remove the cut material, such as for piping applications. Preferably, the thread repair insert 10 includes four containment recesses 16, but may include as few as one containment recess 16 or may contain more than four depending on the particular implementation. The size of the individual containment recesses 16 and the number of containment recesses 16 can be selected based upon the amount of material that is expected to be removed and thus must be retained.

The thread repair insert 10 may be manufactured from any one of a number of known materials, depending on the particular implementation. Preferably, however, the thread repair insert 10 is manufactured from a through-hardened 400 series stainless steel, such as A.I.S.I. 420 stainless steel with a hardness of at least 51-60 HRC. Through-hardening provides a cutting surface that will self-tap into most parent materials, as well as increase interior thread durability in comparison to other materials and/or hardening techniques. The thread repair insert could, however, be manufactured from another metal or a plastic, depending on the particular application.

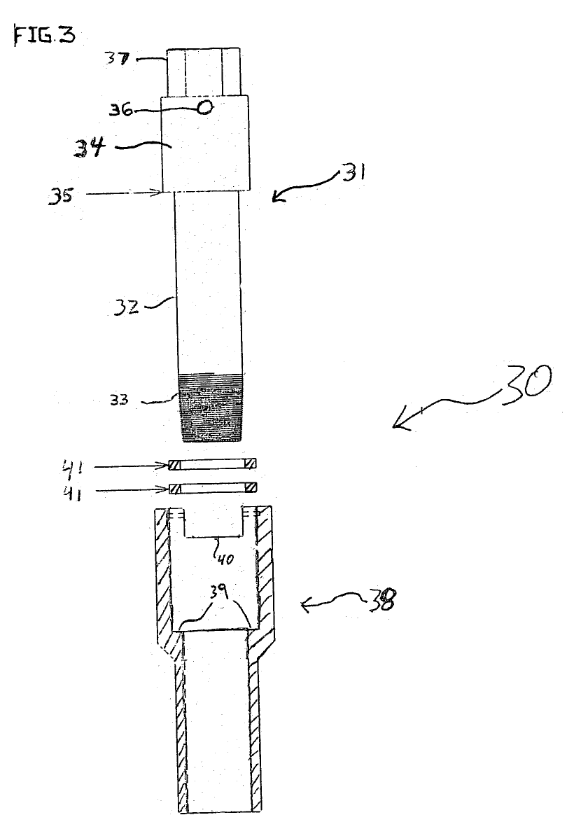

An installation tool 30 for installing a thread repair insert 10 is shown in FIG. 3. The installation tool 30 includes a stud 31, a sleeve 38, and thrust washers 41. This figure shows a side view of the stud 31 and cross-sectional views of the sleeve 38 and thrust washers 41.

The stud 31 has an external surface 32, at least a portion of which has threads 33 extending from a leading edge of the stud 31. The external surface 32 of the stud 31 may be tapered as shown for insertion of a thread repair insert 10 having a tapered internal surface 13, or may be substantially straight (not shown) for insertion of a thread repair insert having a non-tapered internal surface.

The stud 31 also includes a head 34 that provides a step 35 at a trailing edge of the stud 31. The step 35 has a larger diameter than the threads 33 of the external surface 32. In this preferred embodiment, a cross-pin 36 is provided through the head 34. To facilitate rotation of the stud 31, the step 35 is provided at a leading edge of the head 34. The head 34 can be provided with a standard hexagonal engagement portion 37 to mate with a standard hand wrench or socket wrench to facilitate rotation of the stud 31. Other engagement portions may also be used as would be readily apparent to one of ordinary skill in the art after reading this disclosure.

The sleeve 38 is configured to receive the stud 31 such that the step 35 engages a corresponding portion 39 of the sleeve 38 via the thrust washer(s) 41. The sleeve 38 includes notches 40 that receive the cross-pin 36 of the stud 31.

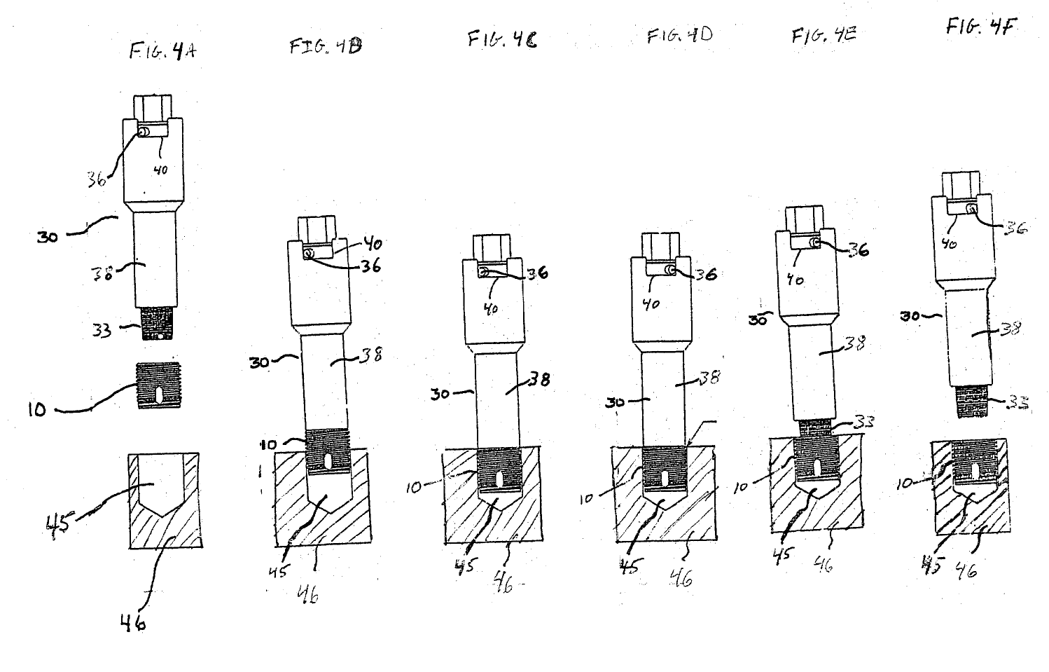

The thread repair insert 10 and installation tool 30 can be used to repair damaged threads as shown in FIGS. 4A to 4F. These figures provide side views of the installation tool 30 and cross-sectional views of the parent material 46. For purposes of explanation only, the thread repair insert 10 of FIG. 1 is depicted being inserted using the installation tool 30 of FIG. 3. Other thread repair inserts and/or other installation tools, however, can also be used as would be readily apparent to one of ordinary skill in the art after reading this disclosure. It should also be appreciated that the following method uses a right handed threading installation, though a left handed threading installation could also be used.

As shown in FIG. 4A, a thread repair insert 10 is aligned with a leading edge of a pilot hole 45. Preferably, the pilot hole 45 is pre-drilled prior to aligning the thread repair insert 10 therewith to remove any damaged threads in the pilot hole 45 or to create a new hole 45 in the parent material 46. The pilot hole 45 can be pre-drilled using any known drilling method.

After the thread repair insert 10 is aligned with a leading edge of the pilot hole 45, the installation tool 30 is engaged with the thread repair insert 10 as shown in FIG. 4B. The stud 31 is then rotated clockwise to cause the cross-pin 36 to stop against sides of the notches 40, thereby putting the installation tool 30 in its proper position to thread insert 10 onto threaded portion 35 until the insert 10 bottoms against the bottom of the sleeve 38. At this point, the sleeve 38 will prevent further insertion of the threaded portion 35 of the stud 31 into the insert 10, and the cross-pin 36 prevents the stud 31 from overtightening onto the insert 10. The installation tool 30 and the insert 10 will be coupled for insertion of the insert 10.

As the insert 10 is rotated clockwise by the installation tool 30, the parent material 46 is cut to form new threads, such that at least one cutting edge of the thread repair insert 10 engages the walls of the pilot hole 45. FIG. 4B depicts the thread repair insert 10 already partially inserted in the pilot hole 45, The thread repair insert 10 is further rotated until a trailing edge of the thread repair insert 10 is flush with or submerged beneath a leading edge of the parent material 46 (FIG. 4C).

As shown in FIG. 4D, after the thread repair insert 10 is fully inserted into the pilot hole 45, the stud 31 is rotated counterclockwise to a release position. The thrust washers 41 allow the stud 31 to slip within the sleeve 38, thus allowing the stud 31 to move cross-pin 36 in notches 40 and thereby loosen the sleeve 38 from insert 10. As the stud 31 continues to rotate counter clockwise, the cross-pin 36 contacts other sides of notches 40 of the engaging sleeve 38, such that the installation tool 30 is in a reverse position.

The installation tool 30 is then disengaged from the thread repair insert 10 by rotating the installation tool 30 in a counterclockwise direction (FIG. 4E). As shown in FIG. 4E, the thread repair insert 10 remains locked within the parent material 46 such that the internally threaded surface 13 (FIG. 2) of the thread repair insert 10 then provides a new threaded hole for receiving a threaded fastener, such as a bolt or pipe.

In the process described above, the installation tool 30 is configured such that it does not become “locked” to the thread repair insert 10 being inserted into the parent material. For example, if a typical installation tool were used to insert a thread repair insert 10 having a tapered internal surface 13, more torque is required to loosen the installation tool 30 from the thread repair insert 10 than to engage it. In other words, when the thread repair insert 10 is being inserted into the pilot hole, the tapered coupling between known installation tools and the thread repair insert 10 causes known installation tools to creep up/extend into the tapered internal threading until the installation tool becomes locked to the thread repair insert 10.

The installation tool 30 of the present invention can be configured to avoid this problem. The sleeve 38 and the thrust washer(s) 41 as well as the cross-pin 36 and notches 40 prevent the threaded portion 35 of the stud 31 from extending too far into the insert 10. During insertion of the insert 10 into the parent material, sufficient insertion pressure is applied by the sleeve 38 against the trailing end 11 of the interference fit between the exterior threads of insert 10 and the walls of the parent material. When it is desired to remove the insertion tool 30, the stud 31 is permitted to begin disengagement from the insert 10 while the sleeve 38 holds the insert in position.

The aforementioned installation tool 30 thus provides for relatively easy installation of a thread repair insert into a parent material. The installation tool 30 can be used with a thread repair insert having a tapered internal thread without locking to the thread repair insert during insertion. Additional advantages may also be realized in application of the aforementioned installation tool 30.

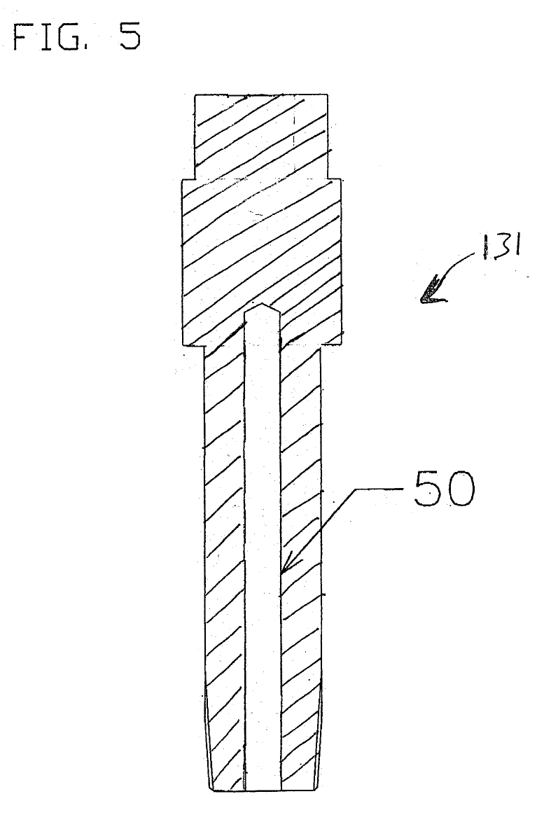

Other modifications can be made to installation tool 30 shown in FIG. 3. For example, as shown in FIG. 5, the stud can be modified to assist in aligning the installation tool 30 with the pilot hole 45 in the parent material 46. This stud 131 is similar in all respects to the stud 31 of FIG. 3, except it has been modified to include a center hole 50. The center hole 50 accepts a dowel pin 51 that can guide and align the tool 30 during installation.

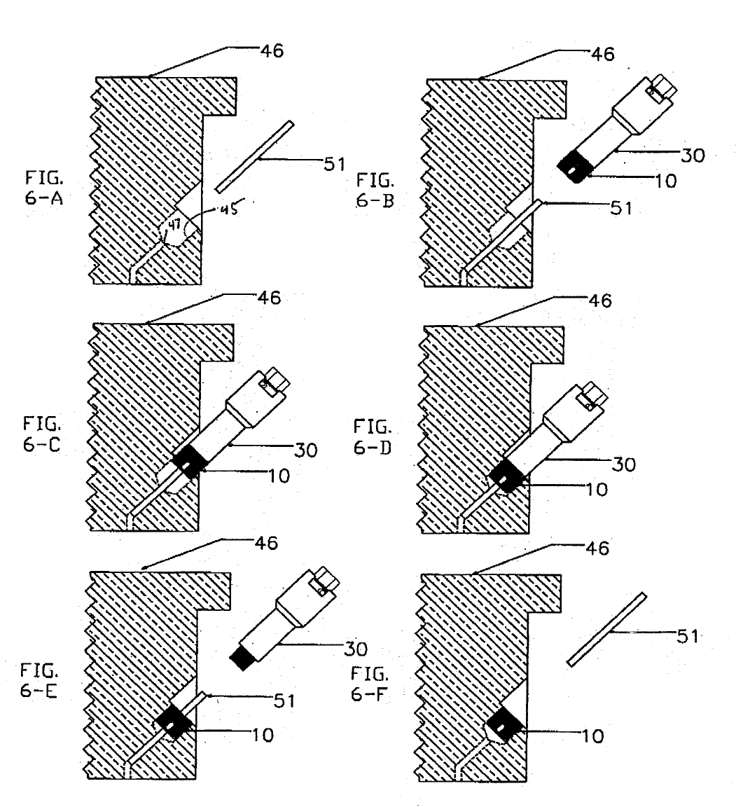

FIG. 6 shows a practical application of installation tool 30 with the modified stud 131. The parent material 46 is a cylinder head from a conventional commercial diesel engine. The cylinder head 46 has a pipe thread hole 45 that accepts a test valve. This hole is often stripped out in use and can be repaired with the thread repair insert 10. The cylinder head 46 has a passage 47 that is on center with the hole to be repaired.

To repair the cylinder head 46, the stripped threads of the hole 45 are removed by drilling them out to the specified size pilot hole required for the thread repair insert 10 to be used. The dowel pin 51 is then inserted into the passage 47. As shown in FIG. 6A, the installation tool 30 having the modified stud 131 is inserted into the hole 45. The insertion tool 30 and insert 10 are slid over dowel pin 51, and the modified stud 131 receives the dowel pin 51 in its center hole 50. The insertion tool 30 must have enough clearance to accept the length of the dowel pin 51 when the tool is at its maximum downward position, so as not to bind the tool or prevent easy installation of the thread repair insert 10. The dowel pin 51 aligns the insert 10 and installation tool 30 relative to the hole 45. The insert 10 is then installed in the same manner as described above in regard to FIGS. 4A to 4F.

As shown in FIG. 6E, the insertion tool 30 is removed from the thread repair insert 10 and slid off the dowel pin 51, leaving the thread repair insert substantially perfectly aligned as if it were the original threads. FIG. 6F shows that the dowel pin 51 is simply removed and the repair is complete. The cylinder head 46 may now be returned to service.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. A thread repair insert, comprising:
an external surface at least partially threaded; and
at least one containment recess formed in the external surface and spaced a distance from a leading end of the insert, the containment recess including at least one cutting edge for cutting material to form threads and being configured to retain substantially all of the cut material.

2. The thread repair insert of claim 1, further comprising:
an internal surface including at least a portion that is threaded.

3. The thread repair insert of claim 2, wherein the internal surface tapers inward in a direction from a trailing end toward a leading end of the thread repair insert.

4. The thread repair insert of claim 3, wherein the tapered threaded portion of the internal surface includes at least a portion with pipe threads adapted to sealably couple to a threaded pipe.

5. The thread repair insert of claim 1, wherein the thread repair insert is formed of through hardened metal.

6. The thread repair insert of claim 1, wherein the thread repair insert comprises at least four containment recesses.

7. The thread repair insert of claim 1, wherein the containment recess has one of a substantially circular cross-sectional shape and a substantially ovular cross-sectional shape.

8. The thread repair insert of claim 1, wherein the external surface includes at least a portion that is threaded and tapers outward in a direction from a leading end of the thread repair insert toward the at least one containment recess.

9. A thread repair insert, comprising:
an annular sleeve including:
an external surface including at least a portion that is threaded;
an internal surface including at least a portion that is threaded and tapers inward in a direction from a trailing end toward a leading end of the annular sleeve; and
a cutting edge formed on the external surface for cutting material to form threads.

10. The thread repair insert of claim 9, wherein the tapered threaded portion of the internal surface includes at least a portion with pipe threads adapted to sealably couple to a threaded pipe.

11. The thread repair insert of claim 9, wherein the annular sleeve is formed of through hardened metal.

12. The thread repair insert of claim 9, further comprising at least one containment recess formed in the external surface and spaced a distance from the leading end of the annular sleeve, the containment recess including the cutting edge and being configured to retain substantially all of the cut material.

13. The thread repair insert of claim 12, wherein the thread repair insert comprises at least four containment recesses.

14. The thread repair insert of claim 12, wherein the containment recess has one of a substantially circular cross-sectional shape and a substantially ovular cross-sectional shape.

15. The thread repair insert of claim 9, wherein the external surface includes at least a portion that is threaded and tapers outward in a direction from the leading end of the annular sleeve toward the cutting edge.

16. A thread repair insert, comprising:
an annular sleeve including:
a cutting edge for cutting material to form threads,
wherein the annular sleeve is formed of through hardened metal.

17. A thread repair insert, comprising:
an annular sleeve including:
an external surface including at least a portion with threads;
an internal surface including at least a portion with pipe threads and adapted to sealably couple to a threaded pipe; and
a cutting edge formed on the external surface for cutting material to form threads.

18. The thread repair insert of claim 17, wherein the pipe threads taper inward in a direction from a trailing end toward a leading end of the annular sleeve.

19. The thread repair insert of claim 17, wherein the annular sleeve is formed of through hardened metal.

20. The thread repair insert of claim 17, further comprising at least one containment recess formed in the external surface and spaced a distance from a leading end of the annular sleeve, the containment recess including the cutting edge and being configured to retain substantially all of the cut material.

21. The thread repair insert of claim 20, wherein the thread repair insert comprises at least four containment recesses.

22. The thread repair insert of claim 19, wherein the containment recess has one of a substantially circular cross-sectional shape and a substantially ovular cross-sectional shape.

23. The thread repair insert of claim 17, wherein the external surface includes at least a portion that tapers outward in a direction from a leading end of the annular sleeve toward the cutting edge.

24. A method of repairing damaged threads, comprising:
aligning a thread repair insert with a leading edge of a hole;
rotating the thread repair insert;
tapping into the hole by cutting material with at least one cutting edge of the thread repair insert while rotating the thread repair insert; and
storing substantially all of the cut material in a containment recess on an external surface of the thread repair insert.

25. The method of claim 24, wherein the thread repair insert has an internal surface including at least a portion with pipe threads and adapted to sealably couple to a threaded pipe.

26. The method of claim 24, further comprising:
preventing an insertion tool from locking with the thread repair insert.

27. The method of claim 24, further comprising:
releasing an insertion tool from the internal surface of the thread repair insert after tapping into the hole.
